(19) United States
(12) Patent Application Publication
(10) Pub. No.: US 2006/0190111 A1
(43) Pub. Date: Aug. 24, 2006

(54) System and method of designing a product or a module therein based on experiences of modular designs accumulated previously

(76) Inventors: Wang Beniz, Taipei (TW); Chang Paul, Taipei (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(21) Appl. No.: 11/050,085

(22) Filed: Feb. 3, 2005

(51) Int. Cl. G06F 19/00

(52) U.S. Cl. 700/97; 706/919

(57) ABSTRACT

A system of designing a product having a predetermined number of modules or a module therein based on experiences of modular designs accumulated previously by the system is disclosed, comprising a designer operating interface, a component database, a product module database, a modular imitation and arrangement module and a design adjustment module. A method of designing a product having a predetermined number of modules or a module therein based on experiences of modular designs accumulated previously is also disclosed, comprising the steps of providing specifications of the product, determining if there is an imitable module in a product module database with respect to each of the predetermined number of modules of the product, acquiring and arranging information associated with a portion of the predetemined number of modules of the product that is determined as yes as a portion of selected information or acquiring and modifying or re-designing the information associated with the other portion of the predetermined number of modules of the product that is determined as no as the other portion of the selected information, storing the modified or re-designed information and simulating by a computer the selected information. With the experiences of modular designs accumulated in the system, a design time for each of successive product design tasks are reduced since some arrangement and design jobs of components and modules may be skipped.

### BACKGROUND OF THE INVENTION

1. Field of the Invention

The present invention relates to a system and method of designing a product or a module therein, and particularly to a system and method of designing a product or a module therein based on experiences of modular designs accumulated previously.

2. Description of the Related Art

In designing products in a prior manner, components therein are generally aligned or arranged to their desired relative positions and then outline and structure are designed therefor. However, each product design task corresponds to a brand new combination of components and modules and requirements for a structure therefor may not be perceived at a beginning stage with regard to the particular product design task. Hence, a structure of the product may be obtained only after a relatively time consuming testing and verifying process. In this case, process time spent in design of the new product may not be efficiently decreased. Also, in spite that the number of the components forming the new product does not vary as compared to that of a finished product, the structure for the new product may not use that of the finished product and requires a brand new design. In addition, since prior experiences of product designs are not adequately and effectively accumulated and arranged, commensurate effort and time are also required to be put in arrangement of components and modules of each new product design as compared to any commensurate product design performed previously. In this manner, labor and cost are senselessly wasted in the commensurate new product design task. Not only the cost for the product design may not be efficiently used, but also a sound design may not be accomplished with respect to the product design task of new specifications.

Therefore, there is a need to provide a system and method of designing a product or a module therein based on experiences of modular designs accumulated previously so that the disadvantages encounterd in the prior arts may be overcome where commensurate labor and time are required for arrangement and design of components and modules as compared to an old product design whenever a new product associated with the arrangement and design of the components and modules is developed.

### SUMMARY OF THE INVENTION

It is, therefore, an object of the present invention to provide a system and method of designing a product having a predetermined number of modules or a module therein based on experiences of modular designs accumulated previously, by which a design time of the product are reduced since some arrangement and design jobs of the components and modules may be skipped and thus labor and time may be efficiently saved.

To achieve the above mentioned object, the system of designing a product having a predtermined number of modules or a module therein based on experiences of modular designs accumulated previously in accordance with the present invention comprises a designer operating interface, a compontent database, a product module database, a modular imitation and arrangement module and a design adjustment module.

Further, the method of designing a product having a predetermined number of modules or a module therein based on experiences of modular designs accumulated previously in accordance with the present invention comprises the steps of providing specifications of the product, determining if there is an imitible module in a product module database with respect to each of the predetermined number of modules of the product, acquiring and arranging information associated with a portion of the predetermined number of the product modules as a portion of selected information if yes or acquiring and modifying or re-designing the information associated with the other portion of the predetermined number of the product modules as the other portion of selected information, storing the modified or re-designed information and simulating by a computer the selected information.

With the system and method of designing a product having a predetermined number of muodules or a module therein based on experiences of modular designs accumulated previously in accordance with the present invention, a designer of the product may easily be benefited with the experiences accumulated prior to his product design by the system and the method and needs not to spend time as much as that spent in commensurate effort in a prior commensurate product design since the prior experiences may be located in the product module database and thus an optimal arrangement and combination of the modules in the product may be reached therethrough. As such, not only requirments of rapid speed, labor saving and low cost generally favorable to an under-developed product are accomplished, but also an advantage that any man-made inattention in the prodcut design task may be efficiently avoided, among others, is provided.

The detailed description and implementations of the present invention will be rendered as follows in connection with the accompanying drawings.

### BRIEF DESCRIPTION OF THE DRAWINGS

The invention will become more fully understood from the detailed description given hereinbelow illustration only, and thus are not limitative of the present invention, and wherein:

FIG. 1 shows a schematic chart of a system of designing a product having a predetermined number of modules or a module therein based on experiences of modular designs accumulated according to the present invention;

FIG. 2 shows a flowchart of a method of designing a product having a predetermined number of modules or a module therein based on experiences of modular designs accumulated according to the present invention; and

FIG. 3 shows an example of a module-composed product which may be designed using the system and method according to the present invention.

### DETAILED DESCRIPTION OF THE INVENTION

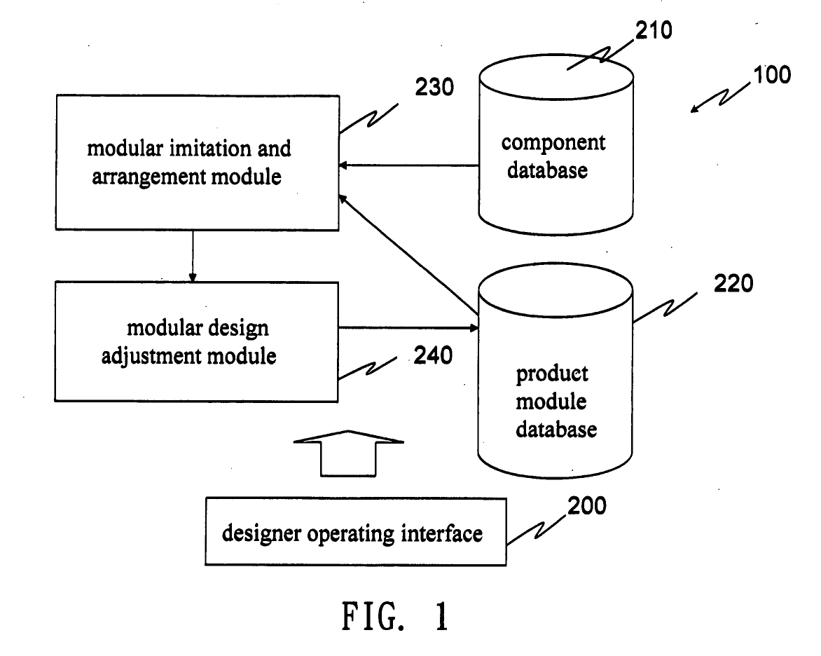

Referring to FIG. 1, a schematic chart of a system of designing a product having a predetermined number of modules or a module therein based on experiences of modular designs accumulated previously in accordance with the present invention is illustrated therein. As shown, in designing a new product or a module therein by using the system 100, a designer thereof has to operate the system through a designer operating interface 200. Through operating the system, experiences of modular designs performed in the same system 100 prior to the designing of the new product or the module therein may be effectively accumulated, and the accumulated experiences of modular designs may be an efficient aid to successive modular design tasks including that a currently conducted design task with respect to the new product or the module therein. It is to be noted that the system of the present invention may be operated and implemented by a computer and the product or module designable by the system may be computer aided design (CAD) products, among others. To enable the present invention to be further understood, the principles of the system of designing a product having a predetermined number of modules or a module therein based on experiences of modular designs accumulated previously in accordance with the present invention will be described below by virtue of the preferred embodiments in connection with the accompanying drawings.

The system of designing a product having a predetermined number of modules or a module therein based on experiences of modular designs accumulated previously in accordance with the present invention comprises the following elements.

1. A component database 100. It is used to store information associated with components having been verified in any mass production.

2. A product module database 220. It is used to store information associated with modules having been used in any product design performed in the system, comprising information associated with relative positions of each module of the product with respect to any modules stored in the product module database and information associated with relative attributes of any module stored in the product module database with respect to the other module stored in the product module database, such as mutual dependencies of any module stored in the product module database.

3. A modular imitation and arrangement module 230. It acquires information associated with modules stored in the product module database identical to a portion of the predetermined number of modules of the product by a designer of the product according to specifications of the product from the product module database through the designer operating interface. In the modular imitation and arrangement module, the designer imitates and arranges information associated with the acquired modules from the product module database so that an optimal arrangement and combination of the components of the acquired modules of the product may be achieved.

4. A modular design adjustment module 240. It acquires the information accociated with the other portion of the predetemined number of modules of the product and the designer may adjust it with the modular design arrangement module according to the specifications of the product through the designer operating interface so that an optimal arrangement and combination of the components of the adjusted modules of the product may be achieved. Further, the other portion of the predetemined number of modules of the product may be re-designed but not merely adjusted. These adjusted or re-designed modules of the product may be stored back into the product module database as “experiences of modular designs acucmulated previously” mentioned herein, with which the successive design tasks may be conducted in a facilitated manner. That is, designers of the successive design tasks may acquire modules as needed from the product module database and imitating and arranging directly them or adjusting them as mentioned above. In an embodiment, the modules may be adjusted by modifying information associated therewith.

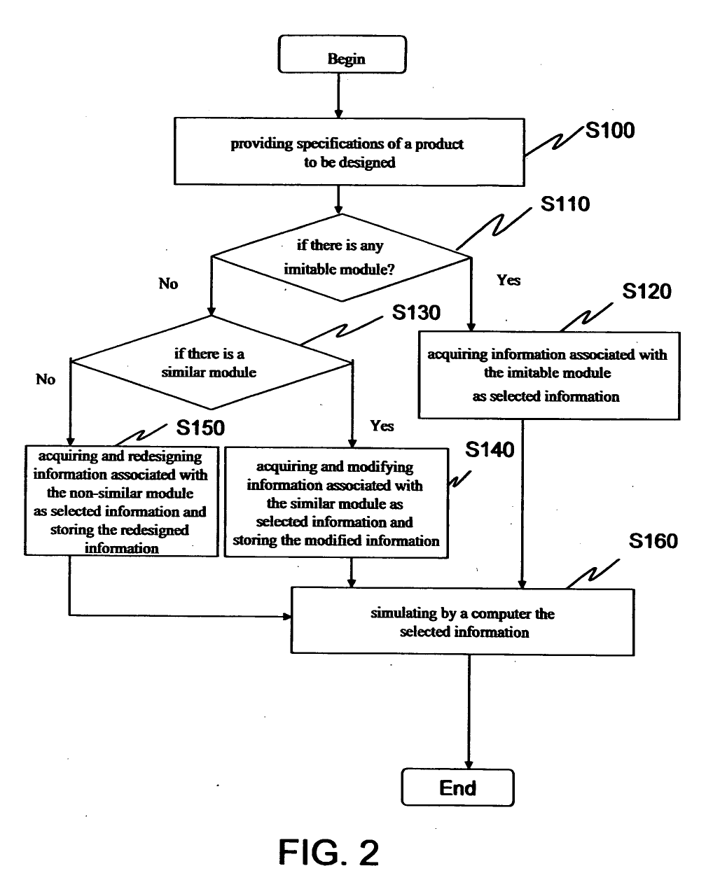

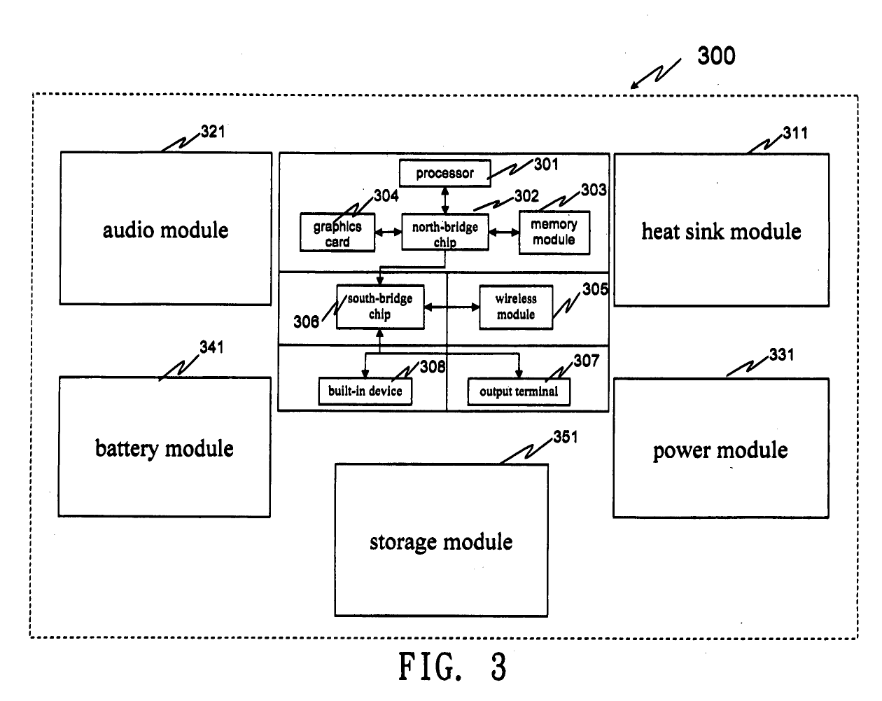

Next, referring to FIGS. 2 and 3. FIG. 2 shows a flowchart illustrating a method of designing a product having a predetermined number of modules or a module therein based on experiences of modular designs accumulated previously in accordance with the present invention. FIG. 3 shows an example of a module-composed product which may be designed using the system and method according to the present invention.

In the method, a designer first provides specifications of the product as intended to be designed (S100). Next, the designer determines if there is any module stored in a product module database which may be imitable by a module of the product (S110). This determination is made over all the modules of the product so that each module of the product may be determined if there is any such a module stored in the product module database that may be imitable directly. Likewise, each module should be subject to all the following steps described below. If it is determined as yes in S110, acquiring information associated with the imitable module from the product module database (S120). Otherwise, the designer determines if there is a similar module stored in the product module database with respect to the module of the product (S130). If it is determined there is actually a similar module in the product module database, the similar module is acquired from the product module database and then modified. Next, information associated with the modified module is stored back to the product module database (S140). It is to be noted that the information stored back to the product module database has to comprise information associated with relative positions between the modified module and the other modules of the product and information associated with mutual dependencies of the modified module with respect to the other modules of the product. The reason that the information associated with the relative positions and the mutual dependencies has to be stored and provided may be known through the following example with reference to FIG. 3. When a processor 301 is given, different heat sink modules 311 may be used to operate in coordination therewith. In this case, the information associated with the relative positions and the mutual dependencies of the processor 301 with respect to these heat sink modules 311 may be relied on to make arrangement and combination of the processor 301 and the heat sink modules 311 optimal according to the specifications of the product. As such, the stored information made in the current product design provides “experiences of modular designs accumulated previously” mentioned herein and may be used for the successive design tasks. When the currently processed module of the product is determined as absent in the product module database, information associated with the components of the module is acquired from the component database and the components corresponding to the acquired information are re-designed. Then, information associated with the re-designed components corresponding to the currently processed module is stored back to the product module database (S150). Likewise, the information stored back to the product module database has to comprise the information associated with the relative positions and the mutual attributes of the module with respect to the other modules of the product, such as mutual dependencies. As such, the information stored in S150 provides “experiences of modular designs accumulated previously” mentioned herein and may be used for the successive design tasks. Finally, simulating by a computer the product composed of the modules determined as the above to obtain an optimal arrangement and combination of the determined modules of the product (S160). Referring again to FIG. 3, this product example comprises a main module group comprising the processor 301, a north-bridge chip 302, a memory module 303 and a graphics card 304 and a secondary module group comprising the heat sink module 311, a wireless module 305, a south-bridge chip 306, an output terminal 307, a built-in device 308, an audio module 321, a power module 331, a battery module 341 and a storage module 351. When the modules in the main module group are aligned on a mother board (not shown), the modules of the secondary module group may have many choices. Through the computer simulation, an optimal arrangement and combination of the modules of the product may be obtained according to the specifications of the product. Preferably, the method as above described is implemented by a computer. Also, the products designable by the method may be CAD products or other products suitable to be designed by the method.

With the system and method of designing a product having a predetermined number of modules or a module therein based on experiences of modular designs accumulated previously in accordance with the present invention, a designer of the product may easily be benefited with the experiences accumulated prior to his product design by the system and the method and needs not to spend time as much as that spent in commensurate effort in a prior commensurate product design since the prior experiences may be located in the product module database and thus an optimal arrangement and combination of each module in the product may be reached there through. As such, not only requirements of rapid speed, labor saving and low cost generally favorable to an under-developed product are accomplished, but also an advantage that any man-made inattention in the product design task may be efficiently avoided, among others, is provided.

While embodiments and applications of this invention have been shown and described, it would be apparent to those skilled in the art having the benefit of his disclosure that many more modifications than mentioned above are possible without departing from the inventive concepts herein. The invention, therefore, is not to be restricted except in the spirit of the appended claims and their equivalents.

What is claimed is:

1. A system of designing a product having a first number of modules based on experiences of modular designs associated with a plurality of number of modules of products accumulated preveiously by the system implemented by a computer, comprising:
a designer operating interface;
a component database storing information associated with a plurality of components;
a product module database storing information associated with the plurality of modules of products having been designed by using of the system;
a modular imitation and arrangement module in which a desinger acquires information associated with a second number of imitation arrangement modules each identical to one of a second number of modules of the product among the first number of modules of the product respectively according to specifications of the product through the designer operating interface and imitates; and
a modular design adjustment module in which the designer acquires information accociated with a third number of adjustment modules each similar to a third number of modules of the product among the first number of modules of the product from the product module database according to the specifications of the product through the designer operating interface and modifies the information associated with the third number of adjustment modules to form a third number of adjusted modules of the product and storing information associated with the third number of adjusted modules of the product into the product module database.

2. The system as recited in claim 1, wherein the designer re-designs a fourth number of modules of the product among the third number of modules of the products absent from the product module database and stores the re-designed fourth number of modules of the product to the product module database.

3. The system as recited in claim 1, wherein the information associated with the plurality of the modules of products having been designed by using of the system comprising information associated with relative positions and mutual dependencies of each of the plurality of modules stored in the product module database with respect to the others of the plurality of modules stored in the product module database.

4. A method of designing a product having a first number of modules implemented by a computer based on experiences of modular designs associated with all modules of products accumulated preveiously and stored in a product module database, comprising the steps of:
providing specifications of the product;
determining if there is a module imitible with each of the first number of modules;
acquiring information associated with a second number of imitation modules as determined imitible with a second number of modules of the product among the first number of modules of the product from the product module database and imitating the second number of imitible modules as a portion of selected information;
acquiring information associated with a third number of adjustment modules as determined non-imitible with a third number of modules of the product among the first number of modules of the product from the product module database and modifying the information associated with the third adjustment modules into information associated with a third adjustmented modules as the other portion of the selected information and storing the information associated with the third number of adjusted modules back to the product module database; and
simulating by the computer the selected information.

5. The method as recited in claim 4, wherein the step of modifiying further comprises a step of resigning each component of each of a fourth number of modules of the prodcut among the third number of modules of the product absent from the product module database.

6. The method as recited in claim 4, wherein the step of simulating avhieves an optimal arrangement of the selected information for the product.

7. The method as recited in claim 4, wherein the step of simulating has an output comprising relative positions and mutual dependencies of each of the first number of modules of the products with respect to the others of the first number of modules of the products.

8. The method as recited in claim 5, wherein the step of simulating has an output comprising relative positions and mutual dependencies of each of the first number of modules of the products with respect to the others of the first number of modules of the products.
